(19) United States
(12) Patent Application Publication
(10) Pub. No.: US 2003/0042058 A1
(43) Pub. Date: Mar. 6, 2003

(54) Detachable motor for scooter

(76) Inventor: Shane Chen, Camas, WA (US)

Correspondence Address: Kevin L. Russell / Chernoff, Vilhauer, McClung & Stenzel, LLP, Suite 1600, 601 S.W. Second Avenue, Portland, OR, 97204, US

(21) Appl. No.: 09/941,390

(22) Filed: Aug. 28, 2001

(51) Int. Cl. B62D 3/00

(52) U.S. Cl. 180/180

(57) ABSTRACT

A scooter assembly has a detachable motor. The motor is biased to urge the motor into engagement with one of the wheels.

### BACKGROUND OF THE INVENTION

The present invention relates to a detachable motor for a scooter.

Scooters are wheeled devices used for individual transportation. A conventional scooter has a running board on which the user stands. The running board is supported by two wheels, one at the front and one at the rear. The front wheel may be steerable by means of a handle bar, which is connected to the front wheel through a steering shaft. The scooter is typically operated by holding the handle bar with two hands, placing one foot on the running board, and pushing with the other foot to propel the scooter.

Recently, motorized scooters have become available. In these types of devices, the motor is usually attached to the rear wheel of the scooter. One problem with many conventional motors is that the motors are heavy and expensive. Another problem is that for electric motors, when the battery for the motor is completely discharged, the scooter can no longer be operated.

What is desired is to provide a scooter that may be motorized, if desired, which can continue to operate if power to the motor is lost, which is light weight and is relatively inexpensive.

### BRIEF SUMMARY OF THE INVENTION

The present invention provides a detachable motor for a scooter.

In a first aspect of the invention, a scooter assembly is provided. The scooter assembly includes a scooter comprising a running board supported by a front wheel and a rear wheel. The front wheel is connected to a handle bar. The assembly further includes a motor assembly detachably mounted to the scooter. The motor assembly comprises a case and a motor. The case houses a battery. The motor is electrically connected to the battery and the motor has a shaft for engagement with one of the wheels. A biasing mechanism operably associated with the motor and the scooter urges the motor shaft into engagement with one of the wheels.

In a second aspect of the invention, a method for operating a motorized scooter assembly is provided. First a scooter is provided comprising a running board supported by a front wheel and a rear wheel. The front wheel is connected to a handle bar. In addition, a motor assembly is provided comprising a case and a motor. The case houses a battery and the motor is electrically connected to the battery and the motor has a shaft for engagement with one of the wheels. The motor assembly is detachably mounted to the scooter. The motor is biased with respect to the scooter to urge the motor shaft into engagement with one of the wheels.

The detachable motor enjoys a number of advantages. First, the motor is easy to install or remove. Thus, the user may either operate the scooter manually, or may engage the motor for mechanized transport. If the battery is fully discharged, the motor may be easily detached from the scooter, allowing manual operation. The motor is very light-weight and relatively inexpensive to manufacture.

The foregoing and other objectives, features and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 shows a side view of a scooter of the present invention.

FIG. 2 shows a partial perspective view of a scooter of the present invention, with the motor case partially cut away.

FIG. 2A shows a detail view of the motor shaft.

FIGS. 3A-3C show several views of a first embodiment of the present invention.

FIGS. 4A-4B show two views of a second embodiment of the present invention.

FIGS. 5A-5B show two views of a third embodiment of the present invention.

FIGS. 6A-6B show two views of a fourth embodiment of the present invention.

FIG. 7 is a schematic diagram of a system used to control power output to the motor.

### DETAILED DESCRIPTION OF THE PREFERRED EMBODIMENTS

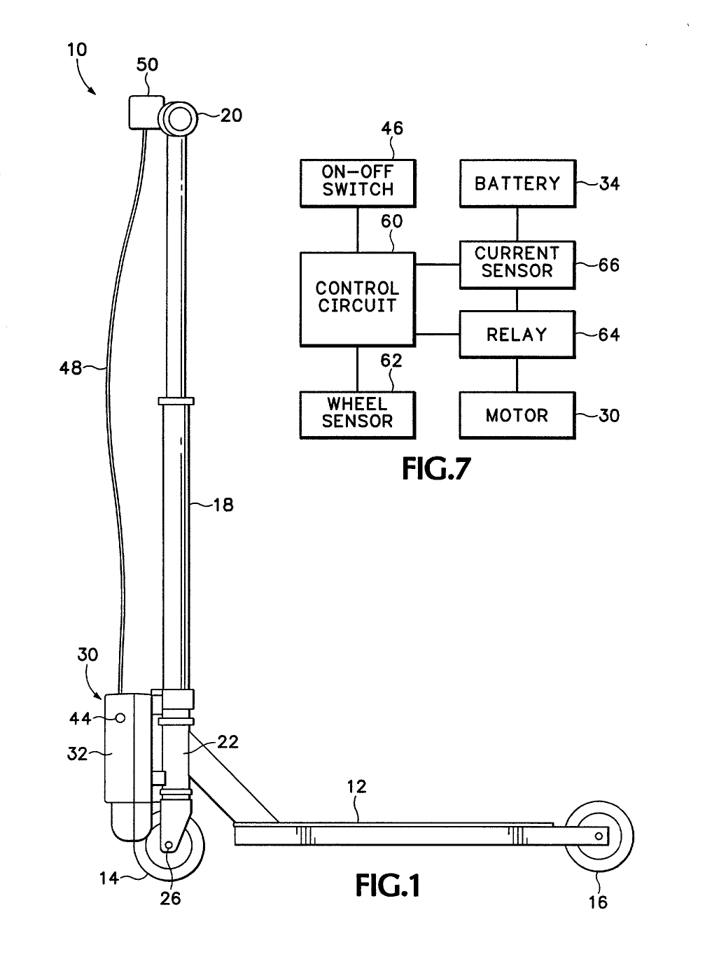

The present invention is directed toward a detachable motor assembly for a scooter. Referring now to the figures, wherein like numerals refer to like elements, an exemplary scooter 10 is shown in FIG. 1 having a running board 12, front wheel 14 and rear wheel 16. A handle bar 20 is attached to the front wheel 14 by means of a steering shaft 18. The steering shaft 18 passes through a yoke 22 which is attached to the running board. The steering shaft may optionally pivot with respect to the running board, and may optionally be collapsible so that the scooter may be folded for convenient storage. As shown in FIG. 1, the detachable motor assembly motor 30 is mounted to the front of the scooter and engages the front wheel 14. While an exemplary scooter has been described and illustrated, the invention is suitable for any conventional scooter or other similar wheeled device to which it is desired to apply a detachable motor.

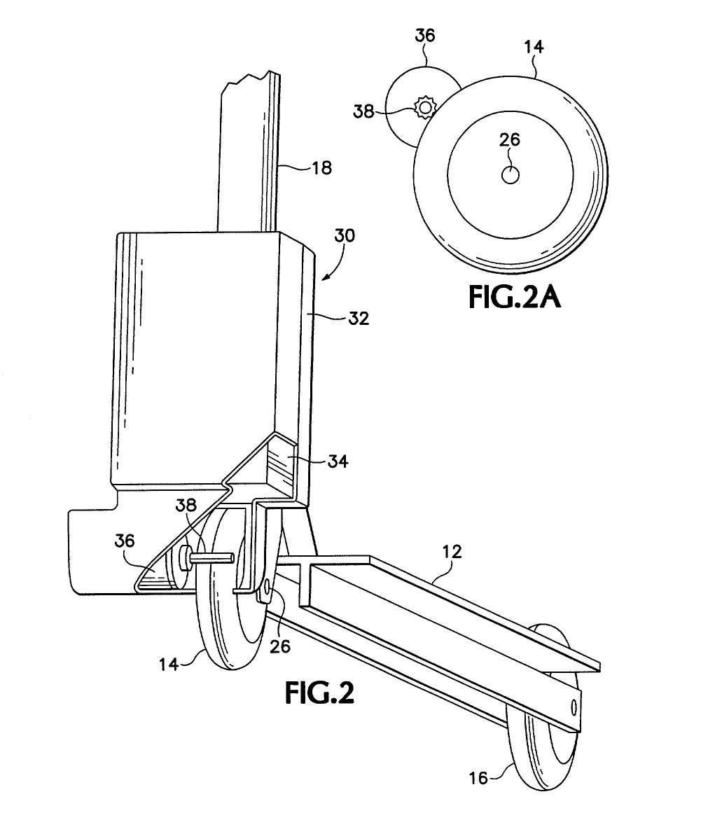

Referring now more particularly to FIG. 2, detachable motor assembly 30 comprises a case 32 containing a battery 34 and an electric motor 36. In FIG. 2, a portion of the case 32 is cut away to reveal the battery 34 and motor 36. The motor 36 has a shaft 38 which engages the front wheel 14. The shaft 38 is preferably toothed, as shown in the detail side view in FIG. 2A. The toothed nature of the shaft 38 allows the shaft to engage the front wheel 14, which may be made from soft polyurethane or other equivalent material.

The motor 36 and battery 34 are chosen to provide sufficient power to the scooter 10. An exemplary motor 36 is a 200 watt, 12-volt DC permanent magnet motor. The battery may be a 12-volt 7-amp•hour battery, such as a sealed lead acid battery. Nevertheless, other motors and batteries may be used as desired according to the needs of the operator.

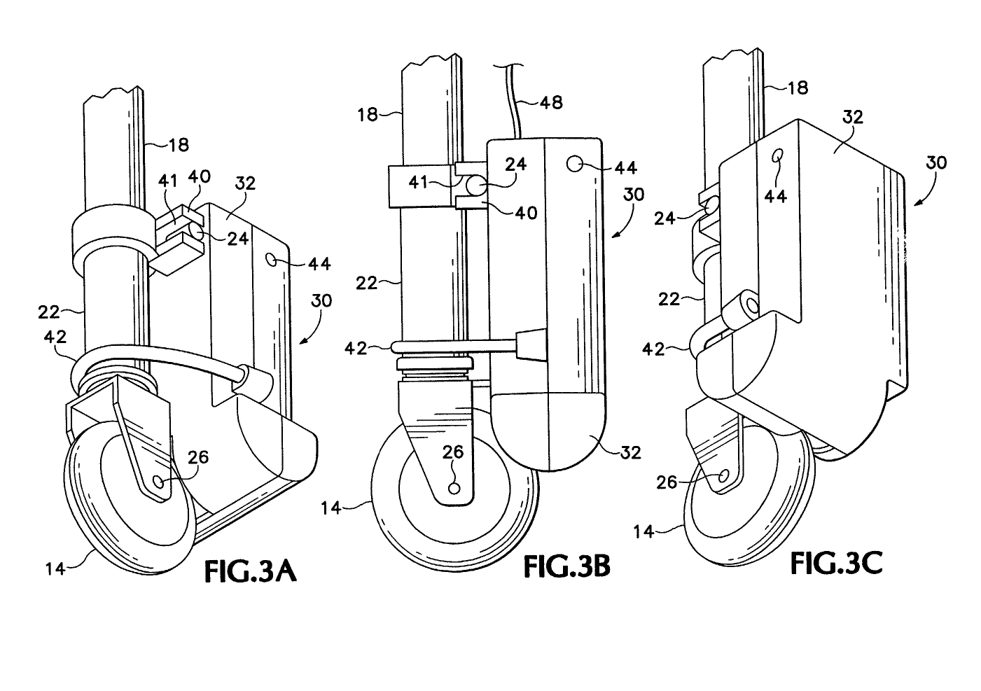

FIGS. 3A-3C show one embodiment of a detachable motor of the present invention. FIG. 3A is a perspective view from the lower rear, FIG. 3B is a side view, and FIG. 3C is a perspective view from the front rear. In this embodiment of the invention, the scooter has a pin 24 which protrudes from the shaft 18 of the scooter 10. The case 32 has a bearing portion 40 to provide a notch 41 for receiving the pin 24. When the pin 24 is received within the bearing portion 40, the case 32 can pivot with respect to the steering shaft 18. The case 32 is held against the yoke 22 by means of an elastic band 42. The elastic band 42 is attached to the case 32 at the two ends of the band. The band 42 is stretched around the yoke 22 in order to secure the motor assembly 30 to the scooter 10. The elastic band 42 detachably connects to the case 32, so that the case 32 may be attached or detached from the scooter as desired.

Mounting the motor assembly to the shaft 18 allows the motor assembly to engage the front wheel. The case 32 turns with the shaft 18 to follow the wheel 14. Mounting the case 32 to the shaft 18 provides an advantage over rear mounted devices because the motor and battery do not interfere with use when mounted in front of the shaft 18. The front mounting of the motor assembly also makes it easier to electrically connect a handle bar mounted controller.

One of the advantages of the present invention is that the motor may be easily disengaged from the wheel. This is accomplished by simply disconnecting one end of the elastic band 42 from the case 32 and detaching the motor assembly. This allows the scooter to be manually operated when desired, such as when the battery is completely discharged.

The elastic band 42 performs two functions. First, as mentioned above, the elastic band 42 acts to securely fasten the case 32 to the scooter 10. Second, the elastic band 42 provides a biasing mechanism to urge the motor shaft 38 into engagement with the wheel 14. It is desired to provide a biasing mechanism that controls the amount of force exerted by the shaft 38 on the wheel 14. In the embodiment illustrated in FIGS. 3A-3C, the elastic band 42 provides tension to urge the shaft 38 into engagement with the wheel 14. However, the case 32, and hence shaft 38, is not in a fixed, rigid relationship to the wheel 14, but is allowed to pivot about the pin 24. Providing such a tensioning mechanism, or biasing mechanism, allows the amount of force exerted by the shaft 38 against the wheel 14 to be easily set at an appropriate level, and allows the motor shaft to move with respect to the wheel in response to forces encountered during operation. Otherwise, if the shaft 38 and wheel 14 are in too firm engagement, then the motor 36 may be damaged when it becomes overloaded. For example, where the operator is attempting to operate the scooter 10 up a steep hill, the motor 36 may be unable to provide sufficient power to propel the scooter uphill. If the motor is held too tightly against the wheel 14 in such a situation, the motor 36 may be overloaded and damaged under such operation. The use of the elastic band 42 allows the shaft 38 to continue to turn in such an event, notwithstanding that the wheel 14 has stopped moving, and thus prevents the motor from being damaged. On the other hand, the elastic band 42 allows the shaft 38 to be held in tight enough engagement during normal operation to allow the shaft 38 to transmit power from the motor 36 to the wheel 14.

The motor assembly 30 has several other features to improve performance. First, the case 32 optionally includes a port 44 to allow the battery 34 to be recharged. The port 44 allows access to one or more electrical contacts which are in electrical communication with the battery 34. The port 44 may receive a standard electrical connector, which may be used to recharge the battery.

The motor assembly 30 also has an on-off switch 46 to control operation of the motor 36. The on-off switch 46 may be electrically connected to a cable, which may be attached to the handle bar 20 of the scooter. This allows the operator to conveniently turn the motor on and off through a hand control 50 mounted to the handle bar 20.

The motor assembly 30 may also contain a control circuit 60 to control operation of the motor 36. For example, as shown schematically in FIG. 7, the control circuit 60 may be used to control power output from the battery 32 to the motor 36. In one embodiment, the control circuit is used to allow power to be provided to the motor 36 only when the wheels 14 and 16 are turning at a particular minimum speed. One problem associated with use of a motor with a scooter is that the scooter, when the motor is turned on suddenly, may accelerate rapidly and be difficult for an operator to control. The present embodiment includes a wheel sensor 62 which monitors rotation of one of the wheels. The control circuit 60 monitors the wheel sensor 62 and provides power to the motor only when the wheels are turning. For example, as shown in FIG. 7, the control circuit may control operation of a relay 64. By controlling the amount of current delivered to the motor 36 in response to rotation of the wheels, the control circuit 60 prevents rapid acceleration of the scooter from a stop or from low speeds. This allows the operator to more easily control the scooter when the motor is turned on.

In addition, the control circuit 60 may also optionally control the amount of power delivered to the motor 36 in response to the operating conditions of the motor. The control circuit may monitor the amount of power or current being supplied to the motor and turn off the motor 36 when the motor 36 becomes overloaded. For example, when the scooter is being used to go up a relatively steep incline, the power requirements may be too great for the motor and the motor 36 may begin to overload. By monitoring a current sensor 66 and turning off the current in such a situation, the control circuit 60 prevents the motor 36 from being damaged under operating conditions which overload the motor.

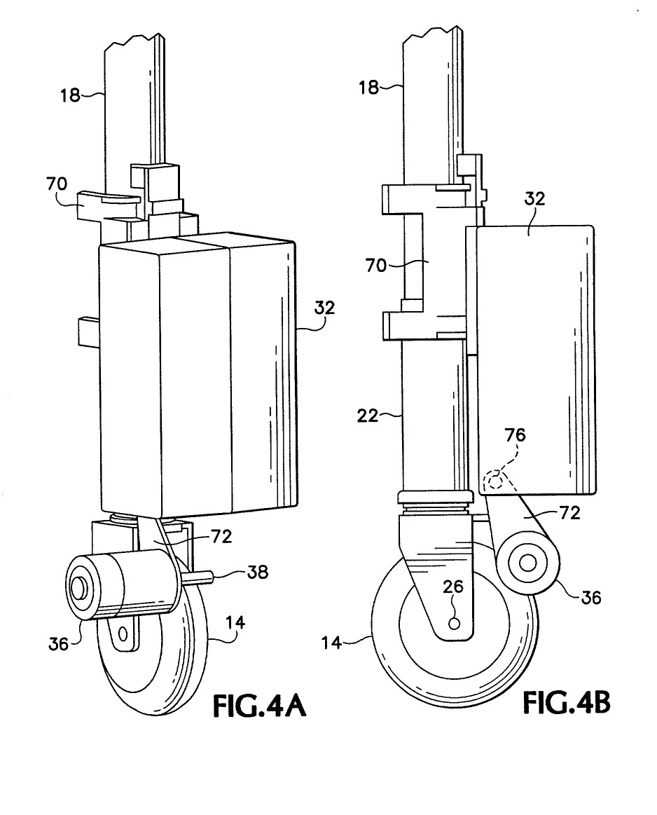

FIGS. 4A-4B show an alternative embodiment of the scooter of the present invention. FIG. 4A shows a perspective view of this embodiment of the detachable motor assembly, while FIG. 4B shows a side view. The motor case 32 is detachably mounted to the scooter 10 by means of a clamp 70. The clamp 70 is securely attached to the shaft 18 of the scooter. The case 32 is slidably adjustable with respect to the clamp 70 so as to adjustably vary the vertical position of the case 32 with respect to the clamp 70. Alternatively, the clamp 70 may be designed such that the clamp 70 may be positioned at several vertical locations with respect to the scooter 10, thus allowing the vertical position of the case 32 to be adjusted with respect to the scooter.

The motor 36 is mounted to the case 70 by means of a bracket 72. The bracket 72 is attached to a pivot pin 74 mounted to the case 32, which allows the motor 36 to pivot with respect to the case 32. A coil spring 76 is attached at one end to the bracket 72 and at the other end to the case 32. The coil spring 76 urges the bracket 72 to pivot away from the case 32, thus causing the shaft 38 of the motor 36 to engage the front wheel 14. The coil spring 76 is thus a biasing mechanism which urges the shaft 38 into engagement with the front wheel 14. In operation, the case 32 is vertically adjustable with respect to the scooter 10 so that the case may be positioned to cause the shaft 38 may firmly engage the front wheel 14. When it is no longer desired to use the motor 14, the vertical position of the case 32 may be adjusted so as to disengage the motor shaft from the wheel.

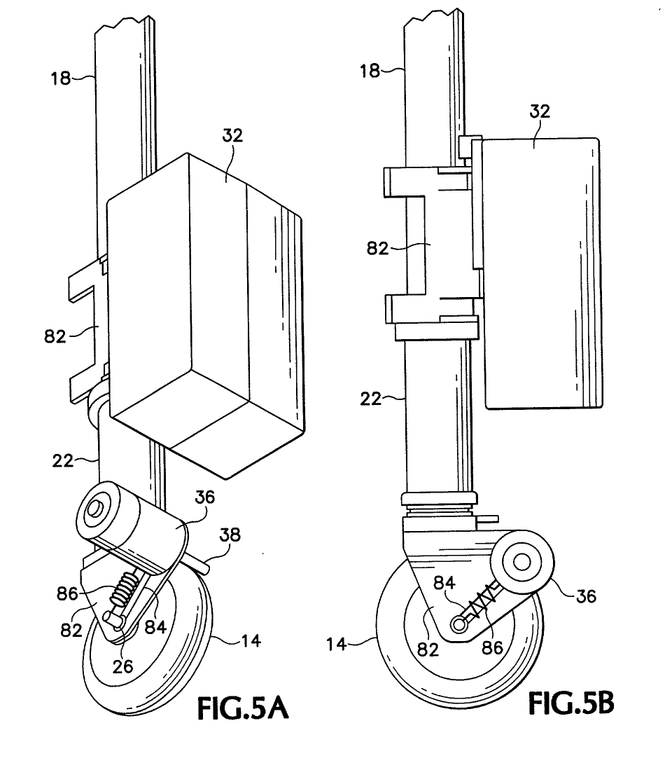

FIGS. 5A-5B show yet another alternative embodiment of a motor assembly 30 of the present invention. FIG. 5A shows a perspective view from the lower front, while FIG. 5B shows a side view. In this embodiment, the case 32 is attached to the scooter by means of a clamp 80. In this embodiment, however, the bracket 82 for mounting the motor 36 is separate from the case 32. The bracket 82 is attached to the wheel axle 26 and optionally the shaft 18 SO as to be mounted adjacent to the front wheel 14. A slot 84 is provided in the bracket 82 for receiving the shaft 38 of the motor 36. A spring 86 is attached at one end to the axle 26 of the front wheel 14, and at the other end to the motor 36. The spring 86 urges the motor 36 toward the axle 26, and thus, urges the shaft 38 into engagement with the front wheel 14. This embodiment of the invention has the advantage that the motor 36 may be separate from the case 32. Thus, the motor 36 may be attached optionally at the front wheel, or at the rear wheel, as desired by the user. The case may also be optionally mounted elsewhere, such as on the handle bar. The bracket 82 includes a mechanism to allow the motor to be disengaged from the wheel 14. The slot extends far enough away from the wheel so that the motor may be pushed away and out of engagement with the wheel. A locking mechanism selectively prevents the motor from moving back toward the wheel. For example, the locking mechanism may be a mechanical fastener, or may be a curved portion of the slot into which the motor shaft may be placed, the curved portion not being axially aligned with the major portion of the slot.

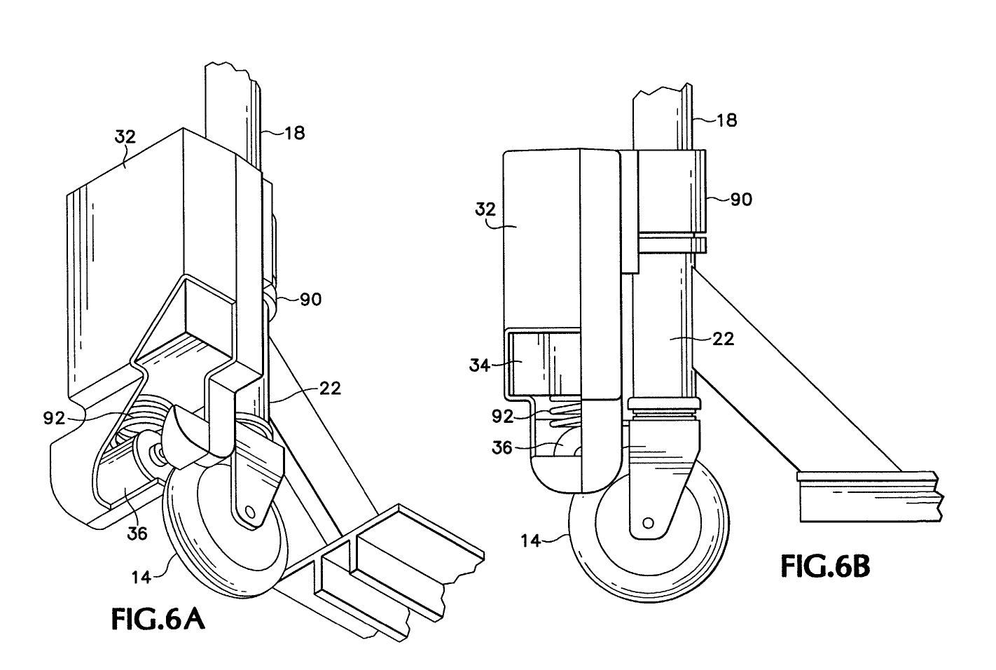

FIGS. 6A-6B show yet another alternative embodiment of the present invention. FIG. 6A shows a perspective view from the lower front with the case partially cut away, while FIG. 6B shows a side view. In this embodiment of the invention, the detachable motor assembly includes a clamp 90 which secures the motor case 32 to the scooter 10. The case 32 is vertically moveable with respect to the scooter. This may be accomplished by either allowing the clamp 90 to move vertically with respect to the scooter 10, or by allowing the case 32 to move vertically with respect to the clamp 90. In either case, the force of gravity urges the case 32 downward so that the shaft 38 of the motor 36 engages the front wheel 14. A spring 92 is interposed between the motor 36 and the battery 34, to provide a biasing mechanism for the motor shaft 38. The spring 92 absorbs shocks experienced during operation, so that the force of engagement with the wheel 14 does not change dramatically during operation.

The terms and expressions that have been employed in the foregoing specification are used as terms of description and not of limitation, and there is no intention, in the use of such terms and expressions, of excluding equivalents of the features shown and described or portions thereof, it being recognized that the scope of the invention is defined and limited only by the claims that follow.

1. A scooter assembly, comprising:
(a) a scooter comprising a running board supported by a front wheel and a rear wheel, said front wheel being connected to a handle bar by means of a steering shaft;
(b) a motor assembly detachably mounted to said scooter comprising a case and a motor, said case housing a battery and said motor being electrically connected to said battery and said motor having a shaft for engagement with one of said wheels; and
(c) a biasing mechanism operably associated with said motor and at least one of said scooter and said case to urge said motor shaft into engagement with one of said wheels.

2. The scooter assembly of claim 1 wherein said motor assembly is detachably mounted to said steering shaft and said motor shaft engages said front wheel.

3. The scooter assembly of claim 1 wherein said biasing mechanism is an elastic band.

4. The scooter assembly of claim 1 wherein said motor is housed within said case.

5. The scooter assembly of claim 1 wherein said motor is external of said case.

6. The scooter assembly of claim 1 wherein said scooter further comprises a pin and said case has a bearing portion for receiving said pin, so that said case is capable of pivoting with respect to said scooter.

7. The scooter assembly of claim 1 further comprising a clamp for attaching said case to said scooter.

8. The scooter assembly of claim 1 wherein said case is vertically adjustable with respect to said front wheel.

9. The scooter assembly of claim 1 further comprising a control mechanism attached to said handle bar to control operation of said scooter.

10. The scooter assembly of claim 1 further comprising a control circuit and a wheel sensor, said control circuit controlling operation of said motor in response to a signal received from said wheel sensor.

11. The scooter assembly of claim 1 further comprising a control circuit and a current sensor capable of monitoring current flow to said motor, said control circuit controlling operation of said motor in response to a signal received from said current sensor.

12. A method for operating a motorized scooter assembly, comprising:
(a) providing a scooter comprising a running board supported by a front wheel and a rear wheel, said front wheel being connected to a handle bar by means of a steering shaft;
(b) providing a motor assembly comprising a case and a motor, said case housing a battery and said motor being electrically connected to said battery and said motor having a shaft for engagement with one of said wheels;
(c) detachably mounting said motor assembly to said scooter; and
(d) biasing said motor with respect to at least one of said scooter and said case to urge said motor shaft into engagement with said one of said wheels.

13. The method of claim 12 wherein said step of detachably mounting said motor assembly to said scooter comprises connecting an elastic band to said case, said elastic band passing around a portion of said scooter.

14. The method of claim 12 wherein said scooter further comprises a pin and said case further comprises a bearing portion, and said step of detachably mounting said motor assembly to said scooter comprises receiving said pin within said bearing portion.

15. The method of claim 12 wherein said step of detachably mounting said motor assembly to said case comprises attaching said case to a clamp mounted to said scooter.

16. The method of claim 12 further comprising the step of detaching said motor assembly from said scooter when said battery is discharged.

17. The method of claim 12 further comprising the step of controlling operation of said motor in response to turning of one of said wheels.

18. The method of claim 12 further comprising monitoring current flow to said motor and controlling said motor in response thereto.

19. The method of claim 12 further comprising the step of disengaging said motor from said one of said wheels and manually operating said scooter while said motor assembly is attached to said scooter.

20. The method of claim 12 further comprising the step of controlling operation of said motor from a control unit mounted on said handle bar.

21. A scooter assembly, comprising:
(a) a scooter comprising a running board supported by a front wheel and a rear wheel, said front wheel being connected to a handle bar by means of a steering shaft;
(b) a case mounted to said scooter and a motor, said case housing a battery and said motor being electrically connected to said battery and said motor having a shaft for engagement with said front wheel;
(c) said motor being mounted to at least one of said steering shaft and an axle of said front wheel of said scooter to engage said front wheel;
(d) a biasing mechanism operably associated with said motor and at least one of said scooter and said case to urge said motor shaft into engagement with said front wheel, and said motor being selectively engageable with said front wheel.

22. The scooter assembly of claim 21 wherein said biasing mechanism is an elastic band.

23. The scooter assembly of claim 21 wherein said biasing mechanism is a spring.

24. The scooter assembly of claim 21 wherein said case is detachably mounted to said steering shaft.

25. The scooter assembly of claim 21 wherein said case and said motor form a motor assembly that is detachably mounted to said steering shaft.

26. The scooter assembly of claim 21 wherein said scooter further comprises a pin and said case has a bearing portion for receiving said pin, so that said case is capable of pivoting with respect to said scooter.

27. The scooter assembly of claim 21 further comprising a clamp for attaching said case to said steering shaft.

28. The scooter assembly of claim 21 wherein said case is vertically adjustable with respect to said front wheel.

29. The scooter assembly of claim 21 further comprising a control mechanism attached to said handle bar to control operation of said scooter.

30. The scooter assembly of claim 21 further comprising a control circuit and a wheel sensor, said control circuit controlling operation of said motor in response to a signal received from said wheel sensor.

31. The scooter assembly of claim 21 further comprising a control circuit and a current sensor capable of monitoring current flow to said motor, said control circuit controlling operation of said motor in response to a signal received from said current sensor.
